(19) United States
(12) Patent Application Publication
(10) Pub. No.: US 2003/0189708 A1
(43) Pub. Date: Oct. 9, 2003

(54) Antitank mine detection system for armored vehicle

(76) Inventor: Seogweon Chang, Incheon (KR)

Correspondence Address: SHERIDAN ROSS PC, 1560 BROADWAY, SUITE 1200, DENVER, CO, 80202

(21) Appl. No.: 10/116,218

(22) Filed: Apr. 3, 2002

(51) Int. Cl. G01B 9/02

(52) U.S. Cl. 356/450

(57) ABSTRACT

Disclosed is an antitank mine detection system for an armored vehicle using pulse electronic speckle pattern interferometry capable of detecting a mine that is buried in the ground, with no influence to the driving speed of the armored vehicle. The system includes an exciter producing the wave motion against the ground with the load itself and the operation speed, an optical source body disposed on the front part of the armored vehicle for irradiating a laser beam as an optical source to an antitank object in the ground, a sensor for taking interference speckle images by collecting the object beam and reference beam from the optical source body and a controller disposed on the armored vehicle body for processing the driving speed of the armored vehicle body, the irradiation speed of the optical source body, and the image of the sensor.

### BACKGROUND OF THE INVENTION

1. Field of the Invention

The present invention relates to an antitank mine detection system for an armored vehicle, and more particularly, to an antitank mine detection for an armored vehicle using pulse electronic speckle pattern interferometry (hereinafter, referred to as ESPI).

2. Background of the Related Art

As well known, an ESPI device is comprised of an optical system with generative patterns produced from interference speckle which chooses two different pattern interferometers in order to detect the overall size of strain vector of a predetermined object that is buried in the ground and the size of vector thereof in a specific direction, respectively, thereby making it possible to obtain the information of the object. The ESPI device is used for non-destructive detection, strain detection, vibration detection and fluidity flow detection, and so on.

On the other hand, an antitank mine, which is buried in the ground, is intended to prohibit forward movement of armored vehicles. Unlike an antihuman mine, the antitank mine has predetermined size and mass and is buried at an appropriate depth in the ground.

A probing pole or a sensor which is mounted on the front end of a specific vehicle is generally used in order to detect the antitank mine. In this case, the probing pole is inserted at a predetermined angle into the ground by a detector, and the sensor is adapted to sense the signal returned from a steel part of the antitank mine through a signal applied therefrom.

The way of detecting the antitank mine with the probing pole or sensor can be carried out intermittently or for a long period of time, but unfortunately, it causes the driving speed of the armored vehicle to be unavoidably low or be broken.

### SUMMARY OF THE INVENTION

Accordingly, the present invention is directed to an antitank mine detection system for an armored vehicle that substantially obviates one or more problems due to limitations and disadvantages of the related art.

An object of the present invention is to provide an antitank mine detection system for an armored vehicle that is capable of detecting a mine that is buried in the ground, while not having a bad effect upon the driving speed of the armored vehicle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this object and other advantages and in accordance with the purpose of the invention, as embodied and broadly described herein, there is provided an antitank mine detection system for an armored vehicle including: an armored vehicle body serving as an exciter; an optical source body disposed on the front part of the armored vehicle body; a sensor disposed on the side of the optical source body, for detecting the fluctuations of an antitank object in the ground by the irradiation of the optical source body; and a controller disposed on the armored vehicle body, for processing the driving speed of the armored vehicle body, the irradiation speed of the optical source body, and the image of the sensor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a schematic view for an antitank mine detection system for an armored vehicle which is at an available state according to the present invention;

FIG. 2 is a block diagram of the antitank mine detection system for the armored vehicle according to the present invention; and

FIG. 3 is a view for the wave motion distortion detected from the antitank mine detection system for the armored vehicle according to the present invention.

### DETAILED DESCRIPTION OF THE PREFERRED EMBODIMENT

Reference will now be made in detail to the preferred embodiments of the present invention, examples of which are illustrated in the accompanying drawings.

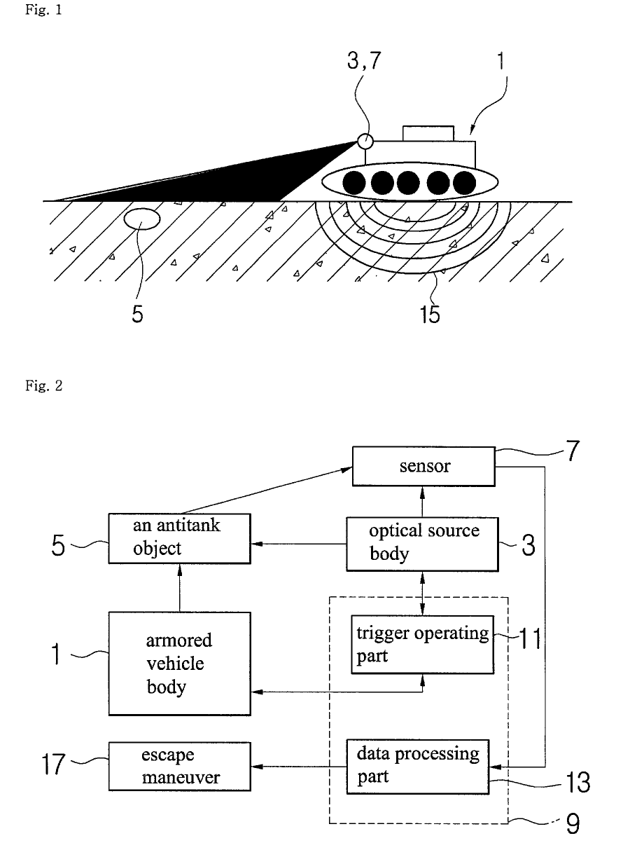

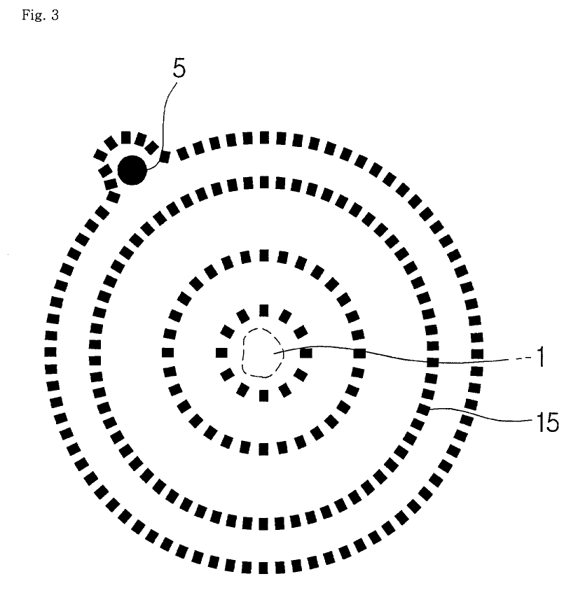

As shown in FIGS. 1 to 3, an antitank mine detection system for an armored vehicle according to the present invention includes an armored vehicle body 1 that serves as an exciter producing the wave motion against the ground with the load itself and the operation speed, an optical source body 3 that is disposed on the front part of the armored vehicle body 1, for irradiating a laser beam as an optical source to an antitank object 5 in the ground, a sensor (CCD) 7 that is disposed on the side of the optical source body 3, for taking interference speckle image by collecting an object beam and a reference beam from the optical source body 3 such that the fluctuations of the antitank object 5 in the ground is detected, and a controller 9 that is disposed on the armored vehicle body 1, for processing the driving speed of the armored vehicle body 1, the irradiation speed of the optical source body 3, and the image of the sensor 7.

The optical source body 3 is further comprised of a beam split, a beam expander and a reflection mirror, if necessary. The beam split serves to separate the reference beam from the object beam, the beam expander serves to expand the object beam or the reference beam, and the reflection mirror serves to induce the object beam to the antitank object 5 in the ground and makes imaging for light scattered from the antitank object 5 in the ground. And, the optical source body 3 is provided with an aperture that is not shown in the drawing, for adjusting the range of the imaging of the light scattered.

The controller 9, which controls the optical source body 3 and the sensor 7, is comprised of a trigger operating part 11 that functions to control the driving speed of the armored vehicle body 1 and the irradiation speed of the optical source body 3 in proportional relation with each other and a data processing part 13 that functions to convert the image sensed by the sensor 7 into an electrical signal and to store or process the electrical signal.

The trigger operating part 11 is adapted to adjust the moving speed of the armored vehicle body 1 and to adjust the irradiation speed of the optical source body 3, thereby obtaining a real-time interference speckle image. The data processing part 13 detects the point where the wave motion 15 is distorted, based upon the interference speckle image and supports the armored vehicle body 1 such that the armored vehicle body 1 conducts an escape maneuver 17. If the point where the wave motion 15 is distorted is detected, it means that the antitank object (i.e., an antitank mine) 5 or a large mass of rock in the ground is disposed at that point. The data processing part 13 compares the data of the distortion position with existing data stored therein to thereby determine whether the antitank object 5 is buried at that point.

According to the present invention, the antitank mine detection system for the armored vehicle detects the antitank mine in the ground, while not having a bad effect on the driving speed of the armored vehicle. To do this, the antitank mine detection system installs the optical source body 3 for irradiating an optical source, on the front portion of the armored body 1 and the sensor 7 to which the reference beam and the object beam are applied, on the side of the optical source body 3. And, the armored vehicle body 1 is provided with the trigger operating part 11 in the controller 9 that controls the driving speed of the armored vehicle body 1 and the irradiation speed of the optical source body 3 in proportional relation with each other and with the data processing part 13 in the controller 9 that receives the information of the antitank object in the ground through the sensor 7 and compares the received information with the existing data.

The optical source from the optical source body 3 is covered up to a predetermined range of the ground in front of the armored body 1, wherein a part of the ground on which the optical source from the optical source body 3 is irradiated is considered as an analysis space for the antitank object 5, and at just the place (i.e., the antitank object 5) where the optical source is irradiated, the interference speckle image is obtained in real-time at the sensor 7. Thus, a generative pattern is produced from the interference speckle image, which is constituted for one optical system, and two different pattern interference meters are chosen in order to detect each of the overall size of the sprain vector and the size of the vector component in a specific direction in the one optical system. With the two different pattern interference meters, the information on the antitank object 5 can be finally obtained.

In this state, the armored vehicle body 1 moves at appropriate speed according to the signal from the trigger operating part 11, and the optical source from the optical source body 3 is appropriately irradiated in proportion to the moving speed of the armored vehicle body 1 according to the signal from the trigger operating part 11. Therefore, the armored vehicle body 1 moves, while forming the wave length (vibration, or wave motion) 15 acting as the exciter around it. When the optical source is irradiated through the optical source body 3, the reference beam and the object beam are obtained in real-time through the sensor 7, and the interference speckle image is applied to the data processing part 13 through the respective beams.

The interference speckle image that is applied to the data processing part 13 is stored in the data processing part 13 and is at the same time analyzed. While the applied signal is being analyzed, if the position where the wave motion is distorted is detected due to the existence of the antitank object 5, the analyzed signal is sent to the driver of the trigger operating part 11 or the armored vehicle body 1. Based upon the analyzed signal, next, it is determined whether the antitank mine exists or not. The transmission of the analyzed signal and the determination on whether the antitank mine exists are carried out in real-time on the characteristics of the pulse ESPI. In accordance with the determination, the moving path of the armored vehicle body 1 is adjusted in real-time such that the escape maneuver 17 from the antitank mine is conducted in a fast manner.

As clearly understood from the foregoing, the antitank mine detection system for the armored vehicle according to the present invention installs the optical source body and the sensor on the front portion of the armored vehicle body serving as an exciter and the controller comprised of the trigger operating part and the data processing part in the interior of the armored vehicle body, whereby the optical source irradiated through the optical source body to the antitank object in front of the armored vehicle body is incident to the sensor, thereby forming the interference speckle image that is transmitted to the data processing part, and the signal transmitted to the data processing part is compared and analyzed to detect the position where the antitank mine is buried in the ground, which is conducted during the movement of the armored vehicle, thereby preventing the armored vehicle from being stopped or decelerated.

In addition, the antitank mine detection system according to the present invention can detect the antitank mine buried in the ground in real-time. If detected, the escape maneuver is conducted by the armored vehicle, and to the contrary, if not detected, the driving of the armored vehicle is accelerated.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An antitank mine detection system for an armored vehicle, said system comprising:
an armored vehicle body serving as an exciter;
an optical source body disposed on the front part of said armored vehicle body;
a sensor disposed on the side of said optical source body, for detecting the fluctuations of an antitank object in the ground by the irradiation of said optical source body; and
a controller disposed on said armored vehicle body, for processing the driving speed of said armored vehicle body, the irradiation speed of said optical source body, and the image of said sensor.

2. The antitank mine detection system according to claim 1, wherein said controller comprises a trigger operating part for controlling the driving speed of said armored vehicle body and the irradiation speed of said optical source body and a data processing part for converting the image sensed by said sensor into an electrical signal and storing and processing the electrical signal.
